(19) United States
(12) Patent Application Publication
(10) Pub. No.: US 2013/0128451 A1
(43) Pub. Date: May 23, 2013

(54) MOUNTING DEVICE FOR FAN MODULE

(71) Applicants: PO-WEN CHIU, Tu-Cheng (TW); WEN-HU LU, Shenzhen City (CN); ZHAN-YANG LI, Shenzhen City (CN)

(72) Inventors: PO-WEN CHIU, Tu-Cheng (TW); WEN-HU LU, Shenzhen City (CN); ZHAN-YANG LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/567,211

(22) Filed: Aug. 6, 2012

(30) Foreign Application Priority Data
Nov. 22, 2011 (CN) 201110373412.6

(51) Int. Cl. F16M 13/02; G06F 1/20

(52) U.S. Cl. 361/679.48; 248/674; 361/679.46

(57) ABSTRACT

A mounting device secures a fan module to a chassis. The mounting device includes a bracket and a spring. The bracket includes a bottom plate and a vent plate substantially perpendicular to the bottom plate. The bottom plate defines a through hole. The spring is fixed on the bottom plate adjacent to the vent plate. The spring includes an elastic portion and a securing tab protruding through the through hole. The elastic portion can retract the securing tab into the bracket.

### BACKGROUND

The disclosure generally relates to mounting devices for fan modules, and especially to a mounting device for retaining a fan module to a chassis.

2. Description of Related Art

Heat dissipation devices, such as fans, are provided in conventional computers to remove heat from heat generating components. These fans are usually fixed to a bracket. The bracket is directly screwed to the computer. However, the traditional manner of bracket assembling is time-consuming. There is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric and partial exploded view of a computer in one embodiment.

FIG. 2 is an exploded, isometric view of the computer of FIG. 1.

FIG. 3 is similar to FIG. 2, but shown from another aspect.

FIG. 4 is a partial assembly view of the computer of FIG. 2.

FIG. 5 is similar to FIG. 4, but shown from another aspect.

FIG. 6 is an assembly view of the computer of FIG. 1.

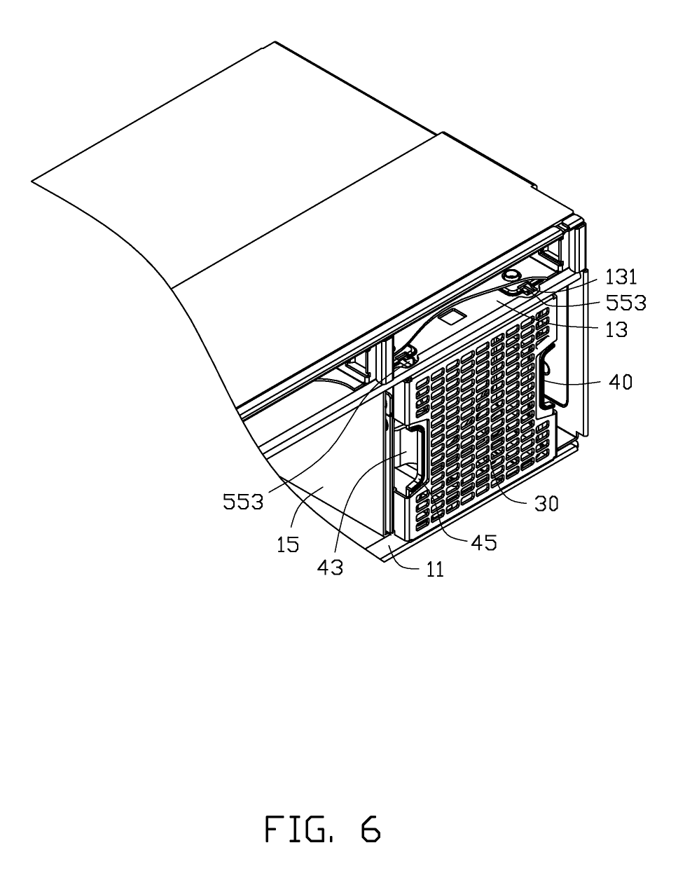

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

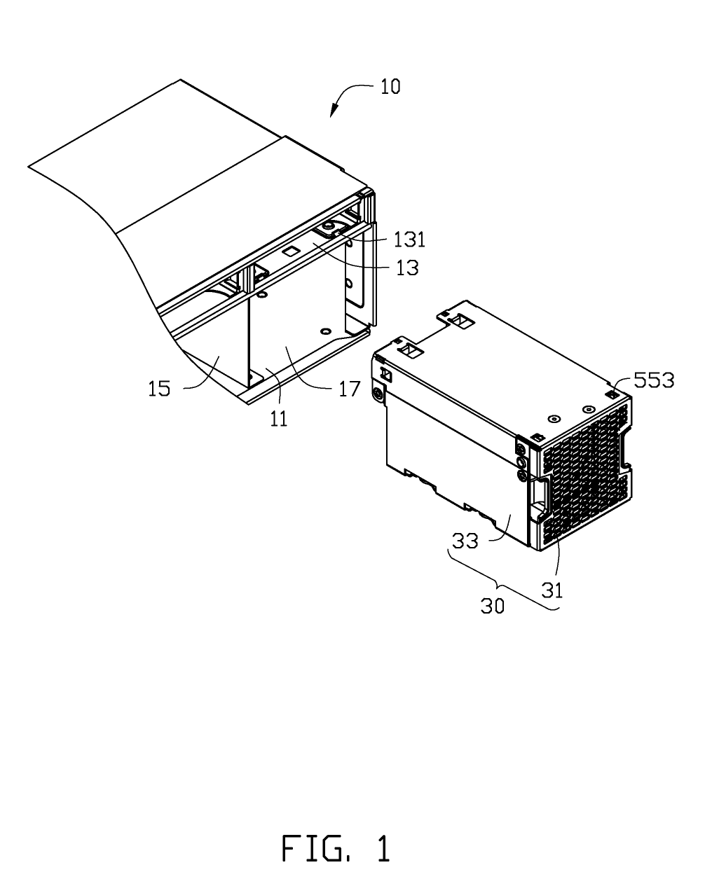

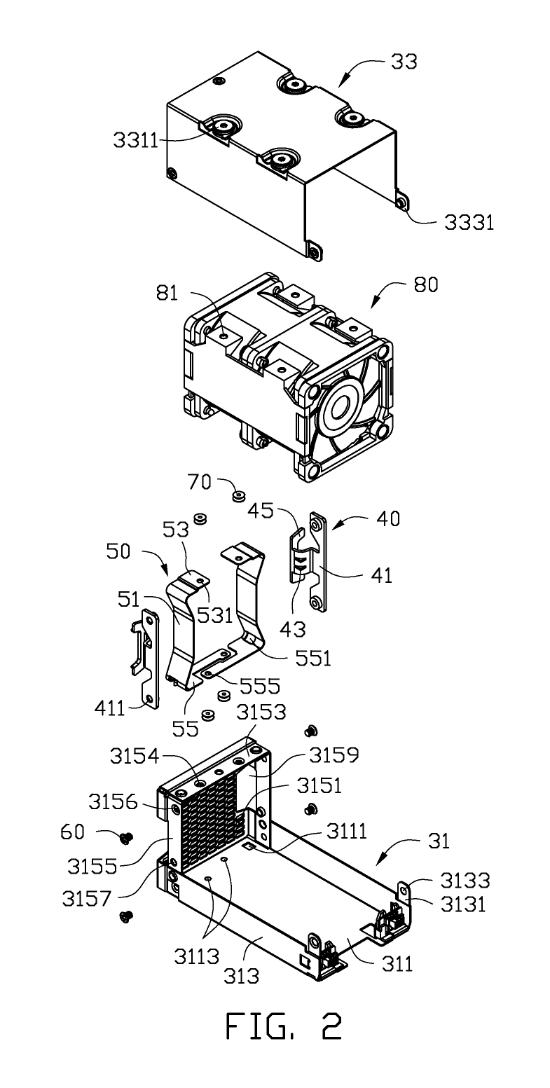

FIG. 1 is one embodiment of a computer. The computer includes a chassis 10, a fan module 80 (see FIG. 2), and a mounting device 30 for mounting the fan to chassis 10.

The chassis 10 includes a bottom wall 11, two sidewalls 15 and a top wall 13. The bottom wall 11 is parallel to the top wall 13. The two sidewalls 15 are parallel to the top wall 13. A receiving space 17 is defined by the top wall 13, the two sidewalls 15, and the bottom wall 11 for receiving the mounting device 30. A retaining hole 131 is defined in the top wall 13.

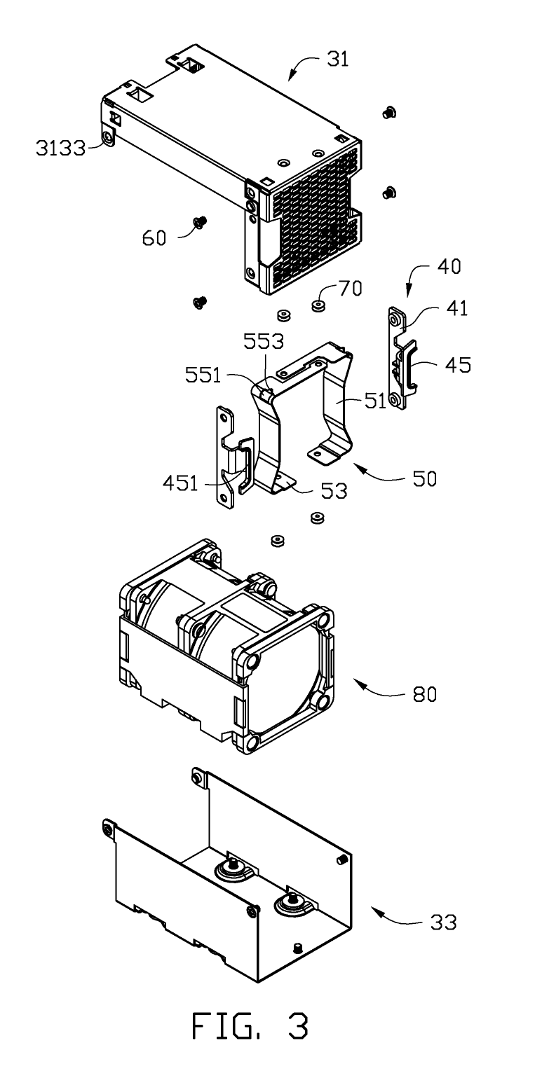

FIG. 2 and FIG. 3, illustrates the mounting device 30 in accordance to one embodiment. The mounting device 30 includes a bracket 31, a cover 33, two springs 50, and two pressing members 40. The bracket 31 includes a bottom wall 311 and a vent plate 3151, perpendicular to the bottom wall 311. Two vertical side flanges 313 are located on the bottom wall 311. Each of the two vertical side flanges 313 includes a first locking piece 3131. A first locking hole 3133 is defined in each first locking piece 3131. A through hole 3111 and two first mounting holes 3113 are defined in the bottom wall 311.

A top securing flange 3153 and two side securing flanges 3155 are located on the vent plate 3151. Each side securing flange 3155 defines a first securing hole 3156 and a second securing hole 3157. A third securing hole 3154 is defined in the top securing flange 3153. Two cutouts 3159 are defined in the vent plate 3151 for receiving the pressing members 40.

Each spring 50 includes an elastic portion 51, a first securing portion 53, and a second securing portion 55. A first fixing hole 531 is defined in the first securing portion 53. A second fixing hole 555 is defined in the second securing portion 55. The elastic portion 51 is curved inside. A securing tab 553 is located at a corner of the spring 50. An opening 551 is defined adjacent to the securing tab 553.

Each pressing member 40 includes a mounting portion 41, an urging portion 43, and an operating portion 45. A mounting hole 411 is defined in the mounting portion 41. The urging portion 43 can resiliently deform.

The cover 33 includes four shock absorption pads 3311 and a second locking portion 3331 corresponding to the first locking portion 3131.

The mounting device can receive a fan module 80. The fan module 80 defines four second locking holes 81.

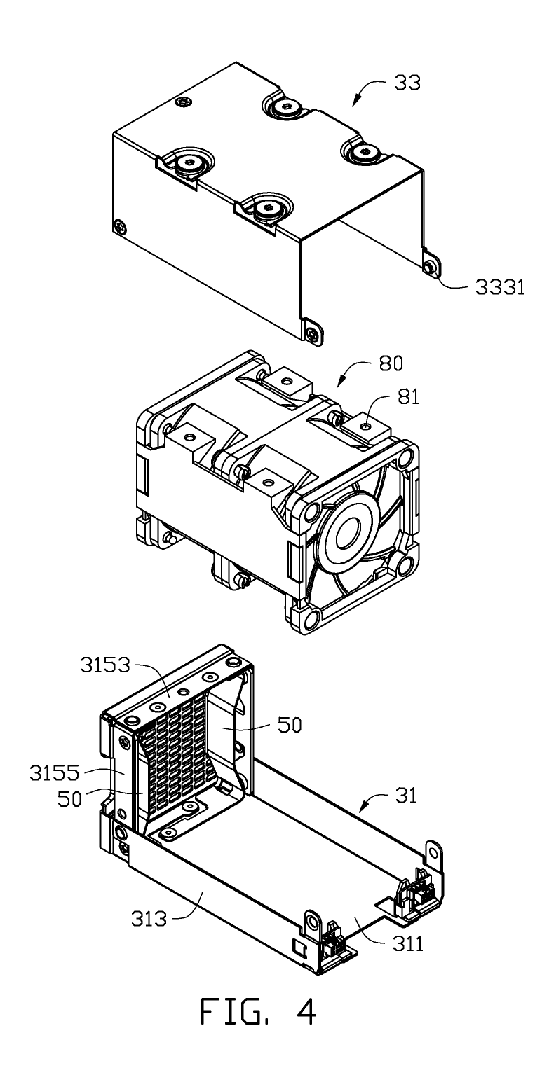

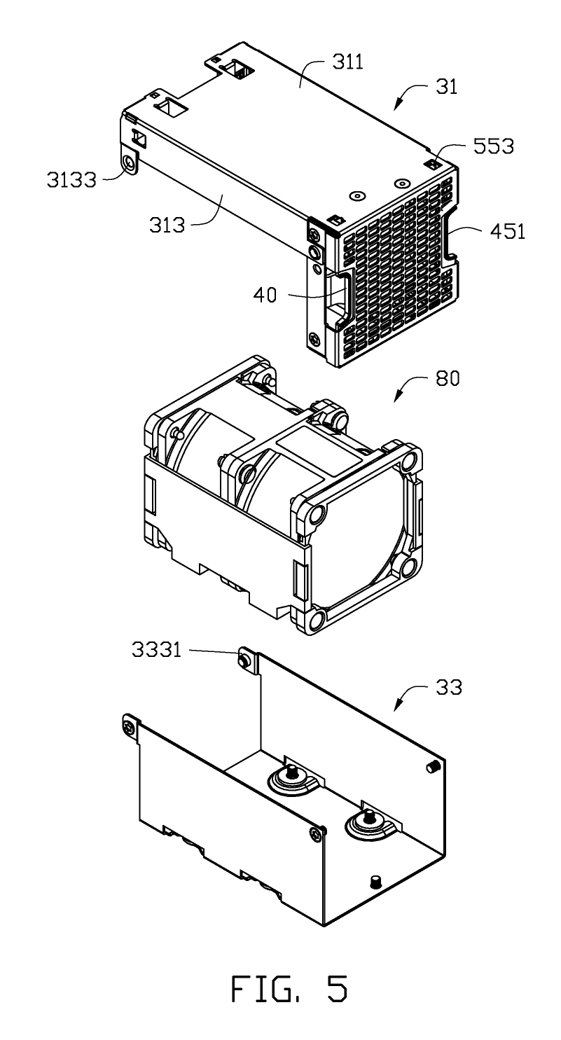

FIG. 3 to FIG. 5, show that, in assembly, the two pressing members 40 are secured to the side securing flanges 3155 through a plurality of fasteners 60. Each operating portion 45 is located in each cutout 3159 of the vent plate 3151. The first securing portion 53 of each spring 50 is secured to the top securing flange 3153 through a first gasket 70. The second securing portion 55 of each spring 50 is secured to the bottom wall 311 through a second gasket 70. The urging portion 43 abuts the elastic portion 51 of the spring 50. The securing tab 553 extends through the through hole 3111.

The fan module 80 is positioned in the bracket 31. The cover 33 is mounted on the bracket 31. The second locking portion 3331 is engaged with the first locking portion 3131. The cover 33 is mounted to the top securing flange 3153. The fan module 80 is located on a side of the vent plate 3151.

When securing the mounting device 30 to the chassis 10, the two operating portions 45 are pressed towards each other. The urging portions 43 urge the elastic portions 51 of the springs 50 to deform inside. The securing tab 553 resides into the through hole 3111. The mounting device 30 is moved into the receiving space 17 of the chassis 10. When the mounting device 30 totally moves into the receiving space 17, the two operating portions 45 are released; the elastic portions 51 are released; and the securing tabs 553 extend into the retaining holes 131 of the chassis 10. The mounting device 30 is mounted to the chassis 10.

When detaching the mounting device 30 from the chassis 10, the two operating portions 45 are pressed towards each other. The urging portions 43 urge the elastic portions 51 of the springs 50 to deform inside. The securing tab 553 retracts from the through hole 3111. The mounting device 30 can be removed from the chassis 10.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A mounting device for securing a fan module to a chassis, comprising:
a bracket comprising a bottom plate and a vent plate substantially perpendicular to the bottom plate, the bottom plate defines a through hole; and
a spring fixed on the bottom plate adjacent to the vent plate, the spring comprises an elastic portion and a securing tab protruding through the through hole,
wherein the elastic portion is configured to retract the securing tab into the bracket.

2. The mounting device of claim 1 further comprising a pressing member fixed on the vent plate, wherein the pressing member is configured to deform the elastic portion of the spring.

3. The mounting device of claim 2, wherein a deforming direction of the pressing member is substantially parallel to the bottom plate and the vent plate.

4. The mounting device of claim 2, wherein the elastic portion is curved inside, and the pressing member abuts the elastic portion.

5. The mounting device of claim 2, wherein the pressing member comprises an urging portion, and the urging portion is resilient.

6. The mounting device of claim 2, wherein the pressing member comprises an operating portion, the vent plate defines a cutout, and the operating portion is located in the cutout.

7. The mounting device of claim 1, wherein the spring is substantially U-shaped.

8. The mounting device of claim 7, wherein the spring is mounted to the bottom plate at one end of the spring, and is mounted to the vent plate at an opposite end of the spring.

9. The mounting device of claim 7, wherein the securing tab is located at a corner of the spring.

10. The mounting device of claim 1 further comprising a cover, wherein the cover is mounted on the bracket to cover the fan module.

11. A computer, comprising:
a chassis defining a retaining hole;
a bracket comprising a bottom plate and a vent plate substantially perpendicular to the bottom plate, the bottom plate defines a through hole; and
a spring fixed on the bottom plate adjacent to the vent plate, the spring comprises an elastic portion and a securing tab,
wherein the securing tab protrudes through the through hole and engages with the retaining hole, and the elastic portion is configured to retract the securing tab into the bracket.

12. The computer of claim 11 further comprising a pressing member fixed on the vent plate, wherein the pressing member is adapted to deform the elastic portion of the spring.

13. The computer of claim 12, wherein a deforming direction of the pressing member is substantially parallel to the bottom plate and the vent plate.

14. The computer of claim 12, wherein the elastic portion is curved inside, and the pressing member abuts the elastic portion.

15. The computer of claim 12, wherein the pressing member further comprises an urging portion, and the urging portion is resilient.

16. The computer of claim 12, wherein the pressing member further comprises an operating portion, the vent plate defines a cutout, and the operating portion is located in the cutout.

17. The computer of claim 11, wherein the spring is substantially U-shaped.

18. The computer of claim 17, wherein the spring is mounted to the bottom plate at one end of the spring, and is mounted to the vent plate at an opposite end of the spring.

19. The computer of claim 17, wherein the securing tab is located at a corner of the spring.

20. The computer of claim 10 further comprising a cover, wherein the cover is mounted on the bracket to cover the fan module.
